(19) United States
(12) Patent Application Publication
(10) Pub. No.: US 2022/0247307 A1
(43) Pub. Date: Aug. 4, 2022

(54) DISTORSION FILTER ARRANGEMENT

(71) Applicant: SAAB AB, Linkoeping (SE)

(72) Inventors: Lars AUSTRIN, Linkoeping (SE); Erik AGERBJOERK, Linkoeping (SE)

(21) Appl. No.: 17/596,516

(22) PCT Filed: Jun. 14, 2019
(86) PCT No.: PCT/SE2019/050568

§ 371 Date: Dec. 13, 2021

(51) Int. Cl. H02M 1/44; H02M 1/12; H02M 7/219; H01F 27/28; B64D 31/00

(52) U.S. Cl. CPC H02M 1/44; H02M 1/126; B64D 2221/00; H01F 27/28; B64D 31/00; H02M 7/219

(57) ABSTRACT

A method and filter arrangement 400 for limiting distortion in a power supply system 420, said filter arrangement 400 being connected to a three-phase power supply device 420 supplying loads RL, said filter arrangement 400 comprising a phase shifting device 470 supplying said loads.

### TECHNICAL FIELD

The present invention generally relates to devices for limiting distortion in power supply systems and more particularly to filtering devices that allow to simultaneously power supply various types of loads in a power supply system with a minimum of impact on the power supply systems and affiliated equipment.

### BACKGROUND ART

In power supply systems, there are high levels of distortion that compromise the connection of different equipment, which each generates distortion. Each distortion adds up to arrive at levels that may exceed the acceptable level of distortion.

In many applications, such as aircraft applications, several standards need to be fulfilled. One of them is the standard MIL-STD-704 that regulates the amount of distortion acceptable in the aircraft power system.

For instance, in aircraft applications, there is a need of using new types of electric motor loads in combination with other loads. These new types of electric motor loads are having a higher level of distortion than previous ones and it is therefore not possible to use more than one at a time. The problem with high distortion levels is based on current commutation in a six-pulse rectifier bridge. The higher load the higher distortion. This is because the amount of distortion depends on the capacity of the supply circuit. If the six-pulse bridge rectifier represents a large percentage of the available capacity of the supply, then the distortion may be substantial.

A feasible solution may be to limit the distortion by using a 12-pulse (or higher) rectifier or using a filter based on inductances and capacitors. In fact, a 12-pulse rectifier uses two six-pulse rectifiers in parallel (12 diodes) to feed a common DC bus. A phase shift is generally obtained between the two current waveforms of the rectifiers by using a three-winding phase shifting converter transformer. Most applications use an isolation transformer with a primary delta winding and two secondary windings. One secondary winding is connected in delta (D) and the other is connected in star (Y), each feeding a 6-pulse rectifier. The problem by using a 12-pulse bridge rectifier is that it weighs more than a standard six-pulse bridge rectifier and the use of a special transformer further increases the costs, weight and also limits available space.

Another solution could be to use a filter based on inductances and capacitors. Such filters are most effective on higher frequencies and will be heavy if used at low frequencies.

### SUMMARY

In view of the related requirements for distortion, it is necessary to create a filter arrangement that can work together with new loads without adding considerable weight, space or costs to the power supply systems.

It is an aspect of the present disclosure to solve the above mentioned problems by providing a filter arrangement for limiting distortion of a power supply system, said filter arrangement being connected to a multiple-phase power supply device supplying a first and at least a second load, said filter arrangement is characterised by comprising: a phase shifting device configured to shift each phase supplying the at least second load so each phase do not coincide with a corresponding phase supplying the first load.

An advantage of the claimed filter is that it takes into account the distortion requirements specified for aircraft applications and other standardised applications with low distortion thresholds.

Further, the phase shifting device may comprise three transformers, each having additional windings. Additional outputs may be provided by extra windings or a combination of several windings.

An advantage of this filter arrangement is that transformers can be kept small and of lightweight with low phase shift. The weight may be significantly lower than any alternative solution.

In addition, the filter arrangement may further comprise a filter adapted to limit the rectifier output to a desired frequency range. This optional filter may be a Pi-filter or LP-filter limiting the frequency level to optimise the power supply system.

Further, the filter arrangement may be used for an aircraft application. As mentioned earlier, several standards need to be fulfilled in this area. One of them is the standard MIL-STD-704 that regulates the amount of distortion in aircraft applications. For this purpose, the filter arrangement will have a great advantage over previous solutions not only because it reduces the total distortion level of the power system but also because it does not contribute excessively in either weight or costs as other known alternatives.

There is provided a system with limited distortion comprising a power supply device adapted to supply electrical power to said multiple-phase power supply system, a plurality of loads, each connected to at least a bridge rectifier adapted to convert electrical power from A/C to D/C, and a filter arrangement connected to the plurality of loads and to the power supply device and comprising the features already mentioned above.

There is also provided a method for limiting a distortion in a multiple-phase power supply system, the method comprising the steps of receiving power input from a power supply device to supply a first load and at least a second load, shifting phases in relation to corresponding phases in said power input for the at least second load, outputting phase-shifted power to the at least second load. In other words, the first load has a non-phase shifted power.

The method and filter arrangement for limiting distortion is generally initiated by the 6-pulsbridge in a power supply system. The filter arrangement comprising a phase shifting device for preventing distortion and does not allow the distortion to add on to and to exceed acceptable levels of distortion to reach the power supply system measured in device. The purpose with the distortion limiting filter arrangement is to reduce the disturbance on the power supply system but even more important is to avoid disturbance on other equipment and systems supplied by the power supply system, such as instruments, radio and other communication systems.

### BRIEF DESCRIPTION OF THE DRAWINGS

Example of embodiments herein are described in more detail with reference to attached drawings in which:

FIG. 1 illustrates a schematic overview of a power supply system according to an exemplary embodiment of the present disclosure.

FIG. 2 illustrates a schematic view of a standard six-pulse bridge rectifier according to the present disclosure.

FIG. 3 illustrates the spectrum and the levels of distortion of a six-pulse bridge rectifier.

FIG. 4 illustrates an exemplary embodiment according to the present disclosure.

FIG. 5A illustrates three one-phase transformers.

FIG. 5B shows a three-phase transformer.

FIG. 5C illustrate a configuration of the windings including a view of a wire-diagram of the relationship of the windings for all three phases respectively, according to an exemplary embodiment of the present disclosure.

FIG. 6 illustrates different phase shifts for each phase output of a three-phase power generated in each of the transformers of the present disclosure.

### DETAILED DESCRIPTION

In the following, a detailed description of exemplary embodiments is presented in conjunction with the drawings to enable easier understanding of the solution(s) described herein.

The exemplary embodiments may be used in several applications within vehicle industry, marine industry, aircraft industry or in any other processing industry.

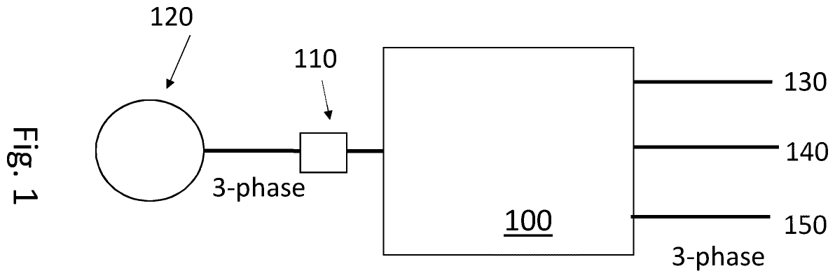

Referring to FIG. 1, a schematic overview of a power supply system according to an exemplary embodiment of the present disclosure is illustrated. The system may be an electric power supply system, comprising a power supply device 120 connected to an optional electrical safety device 110, such as a fuse. The electrical safety device 110 provides overcurrent protection of the electrical circuit of the system and is connected to a filter arrangement 100. The filter arrangement 100 has the main function of preventing that the distortion of each of the components or loads are summed up and coincide in phase/time. The distortion causes interference in the power supply device 120 such as a generator and/or in each of the connected components or loads in the power supply system. In this exemplary embodiment, the filter arrangement uses a three-phase electric power for connecting to a number of electrical load systems 130, 140,150. The electrical load systems may be any electrical motors of high power. As an example, the electrical load systems in the aircraft industry, may be pneumatic ejection systems, air compressor, etc.

There is also provided a method for limiting distortion in a multiple-phase power supply system comprising the steps of receiving power input from a power supply device 120 to supply power to a first load 140 and at least a second load 130, 150. The loads 130, 140 and 150 are supplied by a multiple-phase power system, which in the specific example is supplied by three-phase generator 120 shown in FIG. 1. Thus, each load 130, 140, 150, or additional loads have three-phase power inputs with a phase-difference of only a limited number of degrees between each other. In other words, the main load 140 is supplied directly by synchronous power from the generator 120. The other loads 130, 150 are supplied with three-phase power with an introduced phase-difference of a few degrees from block 100.

The introduced phase-difference is performed by the method by shifting phases in relation to corresponding phases in said power input from the power supply device for the at least second load. For example in a three-phase system, a power input has three different phases A, B, C. The method will shift the corresponding phase for the at least second load, i.e. the phase A for loads 130, 150 will be shifted in relation to the phase A of the power input. The same applies for the remaining phases B and C for the second and third load 130, 150. As explained above, the main load 140 is supplied directly by the generator and no phase-shifting is performed by the method.

The shifting of the phases of the additional loads 130, 150 may be shifted in different directions. For instance, the phases of load 130 may be shifted in a clockwise direction whilst the phases of load 150 may be shifted in a counter-clockwise direction.

The method is then outputting phase-shifted power to said at least second load and non-phase shifted power to said first load.

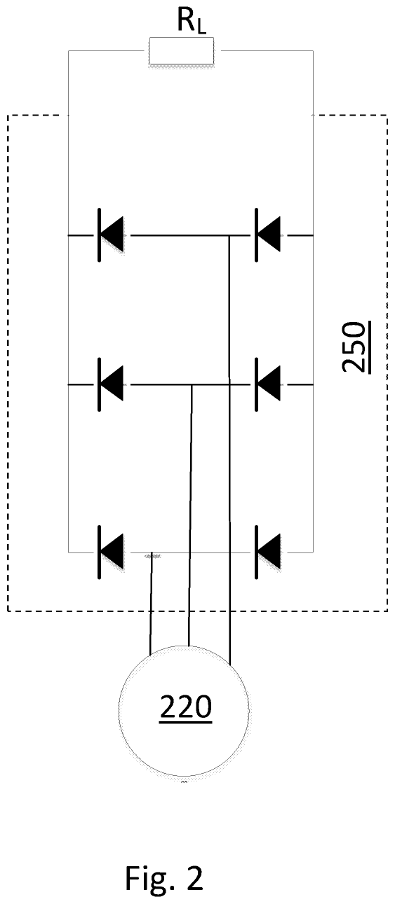

In FIG. 2, a six-pulse bridge rectifier 250 is shown. Such rectifiers are normally used for supplying DC power to any electrical load systems, e.g. electrical motors. However, since each of these systems already may have a high level of distortion, the combination of these systems with bridge rectifiers increases the level of distortion to a level that exceeds standard distortion requirements, e.g. MIL-STD-704 for aircraft applications.

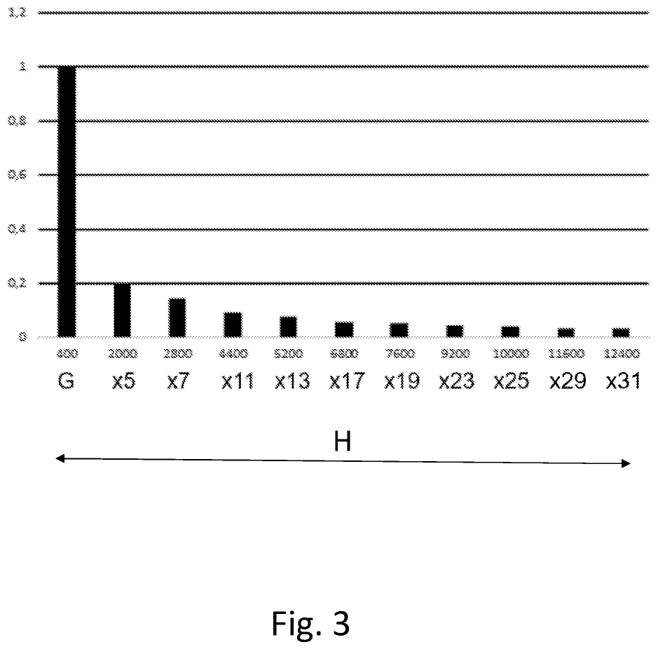

In the exemplary embodiment, the six-pulse bridge rectifier 250 comprises six diodes D1-D6. The six-pulse bridge rectifier 250 is connected to a load R_{L} and a generator 220. The bridge rectifier 250 converts AC signal to DC to supply power to other loads such as cooling systems or any other type of components. The bridge rectifier 250, as a non-linear load, alter the shape of the sinusoidal waveform in any power supply system, creating disturbances in the fundamental tone of that system. These disturbances or distortions are in the form of multiples of the fundamental frequency of the system, also called as harmonics H shown in the spectrum of FIG. 3. The distortion of the harmonic values H are called harmonic distortion (THD) and is the degree to which a waveform deviates from its pure sinusoidal values as a result of the summation of all the harmonic values H. The harmonic distortion may have detrimental effects on electrical equipment. Unwanted distortion can increase the current in power systems, which may result in higher temperatures in neutral conductors and distribution transformers. In addition, higher frequency harmonics cause additional core losses in electrical motors which results in excessive heating of the motor core. Further, higher order harmonics can also interfere with communication transmission lines since they oscillate at the same frequencies as the transmitting frequency. If the harmonic distortion is neglected, it may not only increase temperatures and interference but it may also shorten the life of electronic equipment causing damage to power systems.

A six-pulse bridge rectifier has normally a harmonic distortion in proportion to the fundamental tone G according to FIG. 3.

The vertical axel represents the normalisation of the voltage and the horizontal axel represents the harmonic tones in ascending order. As seen in FIG. 3, H represents the 5^{th}(X5), 7^{th}(X7), 11^{th}(X11), 13^{th}(X13), 17^{th}(X17), 19^{th}(X19), 23^{rd}(X23), 25^{th}(X25), 29^{th}(X29) and 31^{st}(X31), harmonic tones. Each having a level of distortion, which decreases with higher order.

The fundamental tone G that may have a frequency of 400 Hz is normalised (value 1) to a voltage input of 115V. This level of voltage for harmonics is far too high than the levels accepted by the industry. For instance, one of the standards used in the aircraft application is MIL-STD-704 that allows a maximum voltage of 3.16 Vᵣₘₛ for e.g. 2000 Hz signal to meet the Mil-STD-requirements.

Accordingly, the harmonics H are generated by one six-pulse bridge rectifier connected to a load. If many loads are connected to the same power supply system, these harmonics H will add on to the harmonic distortion and will exceed acceptable levels and thereby increase the total level of distortion of the system.

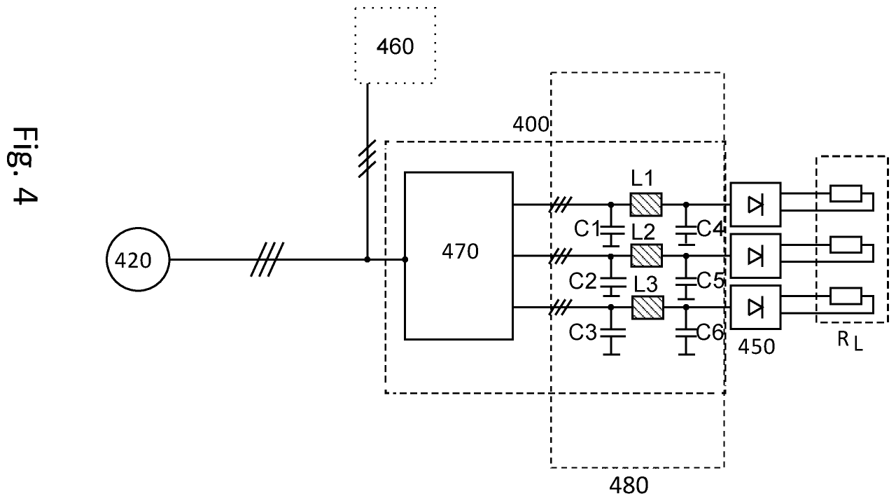

In FIG. 4, an exemplary system according to the present disclosure is shown. The system comprises a generator 420, which supplies a three-phase alternate current AC to the input of a filter arrangement 400. The three-phase power input is the minimum number of phases that is required for such a system but the number of phases in the power input may be more.

In order to have an accurate control of the power input and the level of distortion in the system, an optional measurement device 460 may be used to measure each of the phases of the power input. Each phase in FIG. 4 is drawn as a short oblique line crossing the connection lines. In other words, there are three power input into the filter arrangement, each input representing a phase out of the three-phase power supply. The filter arrangement 400 is further connected to three six-pulse bridge rectifiers 450, each connected to a load R_{L}, for converting alternate current AC to direct current DC. The loads R_{L} may be any type of component that needs to be power supplied by DC to operate.

One of the functions of the filter arrangement 400 is to prevent distortion of the rectifiers 450, to coincide in the time/phase plane so the generator or other loads in the power system are not interfered with the distortion.

The filter arrangement 400 comprises a phase shifting device 470 and an optional filter 480 with several inductors or coils L1-L3 and capacitors C1-C6. Three coils and six capacitors are used in this specific example for each load R_{L}. In this example, the filter arrangement comprises three loads RL to be power supplied resulting in the use of a total of nine coils and eighteen capacitors for this system.

This optional filter 480 has the function of complementing the phase shifting device 470 for a better performance of the system. The optional filter 480 allows limiting the frequency range to a level that is optimal for the system and will limit any frequency anomalies in the system.

As seen in FIG. 4, a Pi-filter is used but other configurations such as a single capacitor with a coil, a LC-filter or a Low-Pass filter (LP) are also possible.

The phase shifting device 470 may comprise at least three one-phase transformers or one three-phase transformer. In this example, three toroidal one-phase transformers are used. The advantage of using a toroidal transformer is that toroidal transformers enables compact solutions.

The transformers used in the phase shifting device 470 are designed to generate a phase shift based on the three-phases of the received power input. It may be possible to use a phase shifting device 470 for phase shift a higher number of phases of a power input if required. However, a minimum of a three-phase power input is recommended.

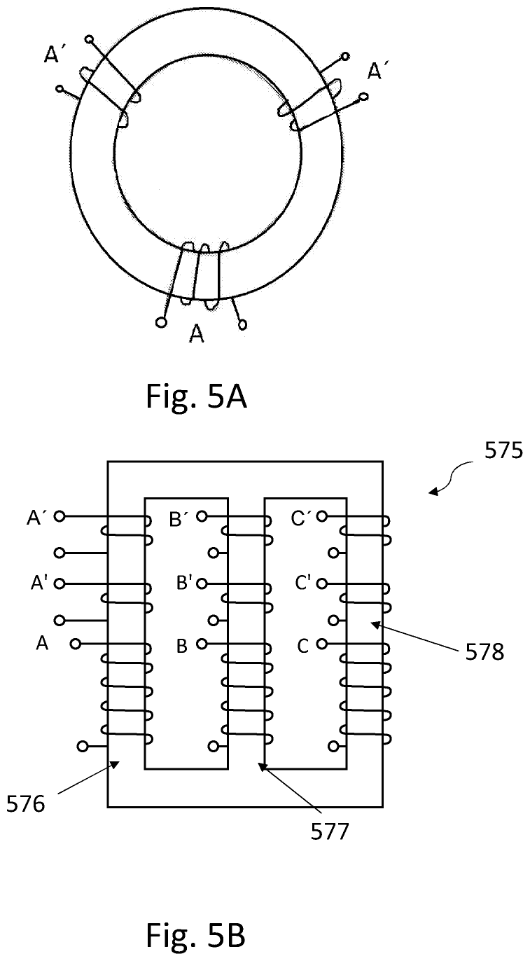

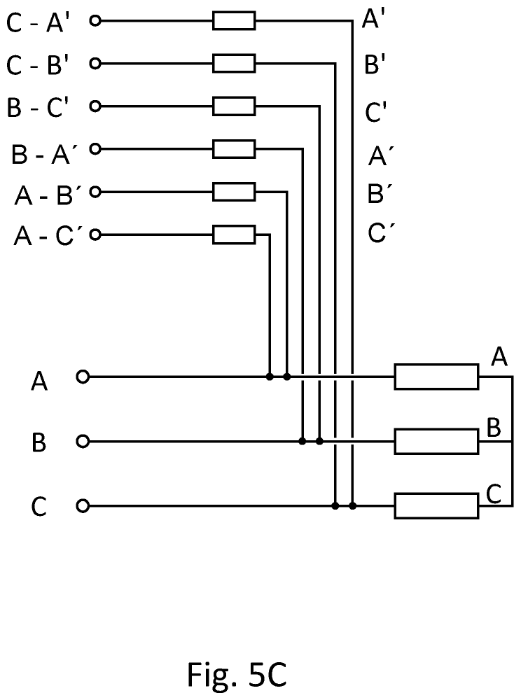

The special configuration of the transformers is shown in detail in FIG. 5A. In the illustrated figure, three one-phase transformers are used in the phase shifting device 470 previously depicted in FIG. 4. Each one-phase transformer is connected to an optional or complementary filter before being connected to a six-bridge rectifier and subsequently to a load or component. In this example, three one-phase transformers are used for each load.

Another type of transformer is shown in FIG. 5B for use in the embodiment shown in FIG. 4 according to the present disclosure. This type is a three-phase transformer 575 having three legs A, B, C, each leg related to a phase. The first leg 576 has three windings A, A′, A′. The predefined number of turns of the secondary windings A′, B′, C′ are approximately 10% of the primary windings A, B, C. A higher percentage results in more windings causing an increase in weight and heat losses.

Extra outputs in the three-phase transformer 575 may be provided by a third winding or a combination of several windings, allowing a phase shifting of the power supply to the loads and avoiding an overlap of harmonic components generated by for instance the six-pulse bridge rectifiers. The effect is less distortion accumulated by all the devices involved in the system.

In the illustrated FIG. 5B, the third winding A′, B′, C′ is added to each leg as extra outputs in the third output to the transformer 575 which may have the same number of turns as the secondary winding if it is considered to be appropriate.

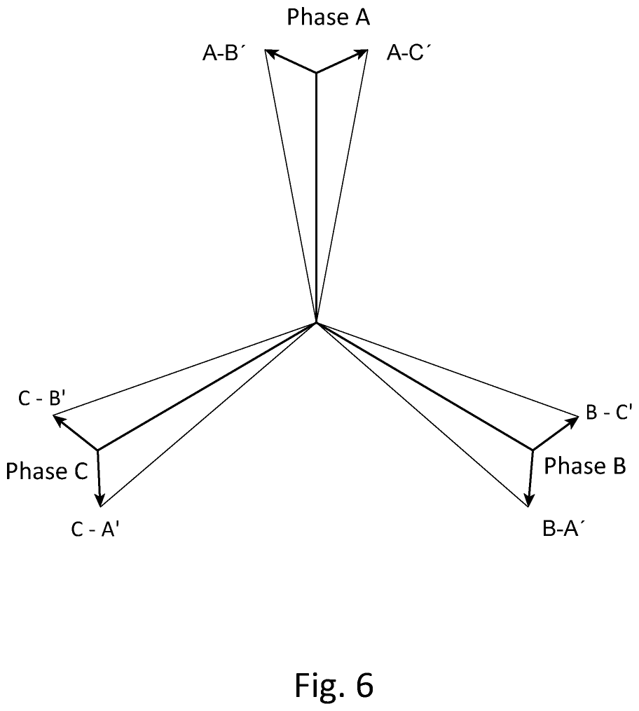

A schematic view of the relationship of the windings for all three phases, independently of the type of the transformer used, is shown in FIG. 5C. In the connection scheme, there are several combinations between the outputs of the first, second and third windings for each leg 576, 577, 578. The first connection C-A′ is the connection between output C and output A′. The second connection C-B′ is the connection between output C and output B′ and so on. All these combinations form phases depicted in FIG. 6.

The different phases A, B and C are the non-shifted phases of the received input from the power supply device. As explained in FIG. 4, several combinations between the outputs of the first and the second windings or between the first and the third windings generate a phase shift in the transformer for phase A, phase B and phase C.

In other words, a combination of primary and secondary windings enables in the described example a total of three sets of three-phase outputs A, B, C. Each phase output A, B or C for a second load or additional loads is phase-shifted by the phase shifting device by using a set of two combinations between primary, secondary and third windings. As shown in FIG. 5C, one combination of the first set of outputs is the primary winding of phase A (A) with the third winding of phase B (B′), i.e. −B′. The other combination of the first set of outputs is the primary winding of phase A with the third winding of phase C, i.e. A-C′. The results of these combinations are the phase deviation of the output phase A from its original phase. In this case, the deviation of the phase-shifted output A is generated by the phase outputs of the third winding of both phase C and B. Similarly, for the phase-shifted outputs B and C, the second set of outputs is B-A′ and B-C′ and the third set of outputs is C-B′ and C-A′. All these combinations are generating three sets of different phase-shifted outputs: Phase A, Phase B and Phase C, shown in FIG. 6. These phase-shifted outputs A, B, C, are displaced both in time and/or frequency. The displacement in time/frequency prevents, for each load, the overlapping of the harmonic distortion components avoiding exceeding acceptable levels of distortion in a power supply system.

The herein described distortion filter arrangement is not limited to three outputs, but could be applied to any number of three-phase loads.

Whilst the invention has been described with respect to illustrative embodiments thereof, it will be understood that various changes may be made in the filter arrangement and means herein described without departing from the scope and the teaching of the invention. Accordingly, the described embodiments are to be considered merely exemplary and the invention or disclosure is not to be limited except as specified in the attached claims.

1. A filter arrangement (100) for limiting distortion of a power supply system, said filter arrangement (100) being connected to a multiple-phase power supply device supplying a first (140) and at least a second load (130, 150), said filter arrangement is characterised by comprising:
a phase shifting device configured to shift each phase supplying said second load (130, 150) so each phase do not coincide with a corresponding phase supplying said first load (140).

2. The filter arrangement according to claim 1, wherein the phase shifting device comprises at least three one-phase transformers or a three-phase transformer, each having additional windings.

3. The filter arrangement according to claim 2, wherein additional outputs are provided by extra windings or a combination of several windings.

4. The filter arrangement according to claim 1, wherein the filter arrangement further comprises a filter adapted to limit the power output to a desired frequency range.

5. The filter arrangement according to claim 1, wherein the filter arrangement is used for an aircraft application.

6. A multiple-phase power supply system for limited distortion comprising:
a power supply device adapted to supply electrical power to a plurality of loads, each connected to at least a bridge rectifier adapted to convert electrical power from A/C to D/C, and
a filter arrangement connected to said plurality of loads and to said power supply device and comprising the features of claim 1.

7. The multiple-phase power supply system according to claim 6, wherein said at least bridge rectifier is a six-pulse bridge rectifier.

8. A method for limiting distortion in a multiple-phase power supply system, said method comprising the steps of:
receiving power input from a power supply device to supply a first load and at least a second load,
shifting phases in relation to corresponding phases in said power input for said at least second load,
outputting phase-shifted power to said at least second load and non-phase shifted power to said first load.

9. The method according to claim 8, wherein the method further comprising the step of limiting the output of the phase shifting device to a desired frequency range.

10. The method according to claim 8, wherein the step of shifting phases in each output of the multiple phases is performed by a phase deviation generated by a combination of different phase outputs.

11. The method according to claim 8, wherein the method is performed by an aircraft application.
